(19) United States
(12) Patent Application Publication
(10) Pub. No.: US 2010/0227720 A1
(43) Pub. Date: Sep. 9, 2010

(54) SPROCKET RANDOMIZATION FOR ENHANCED NVH CONTROL

(75) Inventors: Yogesh Mehta, Auburn Hills, MI (US); Susan Stroope, Oxford, MI (US); Paul M. Walker, Clarkston, MI (US)

Correspondence Address: BORGWARNER INC.;c/o Brown & Michaels, PC, 400 M&T Bank Building, 118 N. Tioga Street, Ithaca, NY, 14850, US

(73) Assignee: BORGWARNER INC., Auburn Hills, MI (US)

(21) Appl. No.: 12/738,407

(22) PCT Filed: Feb. 24, 2009
(86) PCT No.: PCT/US09/34991

§ 371 Date: Apr. 16, 2010

Related U.S. Application Data
(60) Provisional application No. 61/034,288, filed on Mar. 6, 2008.

(51) Int. Cl. F16H 55/30; F16H 7/06

(52) U.S. Cl. 474/155; 474/152

(57) ABSTRACT

A sprocket includes a plurality of teeth along the outer circumference of the sprocket, where the teeth include at least a first tooth variant with a first involute length between a root and a tip radii of the sprocket and a first curvature at a given radius of the sprocket and at least a second tooth variant with a second involute length between a root and a tip radii of the sprocket and a second curvature at the given radius of the sprocket. The first curvature is different than the second curvature at a given radius of the sprocket. Such variants are arranged around the circumference in a predetermined way.

### REFERENCE TO RELATED APPLICATIONS

This application claims one or more inventions which were disclosed in Provisional Application No. 61/034,288, filed Mar. 6, 2008, entitled “SPROCKET RANDOMIZATION FOR ENHANCED RELATED APPLICATIONS”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of sprockets. More particularly, the invention pertains to a random arrangement of teeth with slightly different tooth geometry around a sprocket for enhanced NVH control.

2. Description of Related Art

FIG. 1 shows a schematic of a forty tooth sprocket (01-40) in which all of the teeth are exactly alike or identical within manufacturing tolerances. These teeth have the same involute length and the same curvature at any given radius. With the arrangement shown in FIG. 1, sprocket rotation 2π/k radians, with k being the number of teeth on the sprocket, would be periodic when it operates at constant speed on a shaft. Interaction between the sprocket teeth and chain leads to a high noise vibration and harshess (NVH) response at all the shaft orders (harmonics) that are an integer multiple of k (Θ), k being the number of teeth on the sprocket and Θ being the set of all shaft harmonics which are a positive integer multiples of k. The high NVH response at Θ can be a cause for quality concern.

### SUMMARY OF THE INVENTION

A sprocket includes a plurality of teeth along the outer circumference of the sprocket, where the teeth include at least a first tooth variant with a first involute length between a root and a tip radii of the sprocket and a first curvature at a given radius of the sprocket and at least a second tooth variant with a second involute length between a root and a tip radii of the sprocket and a second curvature at the given radius of the sprocket. The first curvature is different than the second curvature at a given radius of the sprocket. Such variants are arranged around the circumference in a predetermined way. A sprocket of the present invention that uses more than one type of tooth variant is referred to as a “random sprocket”.

The number of tooth variants used on a sprocket can be greater than two and they can be arranged in many different ways as explained below. In a preferred embodiment, at least two tooth variants are present on the outer circumference of the sprocket. In other words, at least one tooth is geometrically different than another tooth on the outer circumference of the sprocket.

The present invention interrupts the periodicity in the prior art baseline sprocket by introducing calculated geometric variations in some of the previously identical sprocket teeth, which decreases the NVH response at the set of the shaft harmonics (Θ), which are a positive integer multiple of k, by redistributing it to other harmonics, thereby achieving an overall NVH attenuation. The extent of redistribution of energy primarily depends on the types and extent of variations on the original tooth design and distribution of these tooth variants on the sprocket. An optimization program is used to best arrange the variants around the sprocket circumference.

### BRIEF DESCRIPTION OF THE DRAWINGS

FIG. 1 shows a schematic of a prior art baseline sprocket with forty teeth that are identical and uses only one type of tooth variant.

FIG. 2 shows one arrangement of three different types of tooth variants using three different involute lengths on a forty tooth random sprocket.

FIG. 3 shows an involute tooth illustrating involute length as a function of roll angle.

FIG. 4 shows curvature of an involute tooth at any arbitrary point P on the involute tooth.

FIG. 5 shows a schematic of a forty tooth random sprocket of the present invention with two tooth variants.

FIG. 6 shows an example of a sprocket that has been drawn to scale.

FIG. 7 shows a schematic of a sprocket showing the different tooth variants used in FIG. 6.

FIG. 8 shows a graph of the NVH response from a prior art baseline sprocket shown in FIG. 1 and a sprocket of the present invention at 150 Nm load with a random chain.

FIG. 9 shows a graph of the NVH response from a prior art baseline sprocket shown in FIG. 1 and a sprocket of the present invention at 150 Nm load with a chain using a first link type (link-1).

FIG. 10 shows a graph of the NVH response from a prior art baseline sprocket shown in FIG. 1 and a sprocket of the present invention at 150 Nm load with a chain using a second link type (link-2), different from the first link type.

FIG. 11 shows a graph of the NVH response from a prior art baseline sprocket shown in FIG. 1 with a random chain in comparison to a sprocket of the present invention with a random chain and a chain with a first link type (link-1) at 150 Nm load.

FIG. 12 shows a graph of the NVH response from a prior art baseline sprocket shown in FIG. 1 with a random chain in comparison to a sprocket of the present invention with a random chain and a chain with a second link type (link-2) at 150 Nm load.

FIG. 13 shows a graph of the NVH response from the prior art sprocket shown in FIG. 1 and the sprocket of the present invention with a random chain at 60 Nm load.

FIG. 14 shows a graph of the NVH response from the prior art sprocket shown in FIG. 1 and the sprocket of the present invention with a random chain at 300 Nm load.

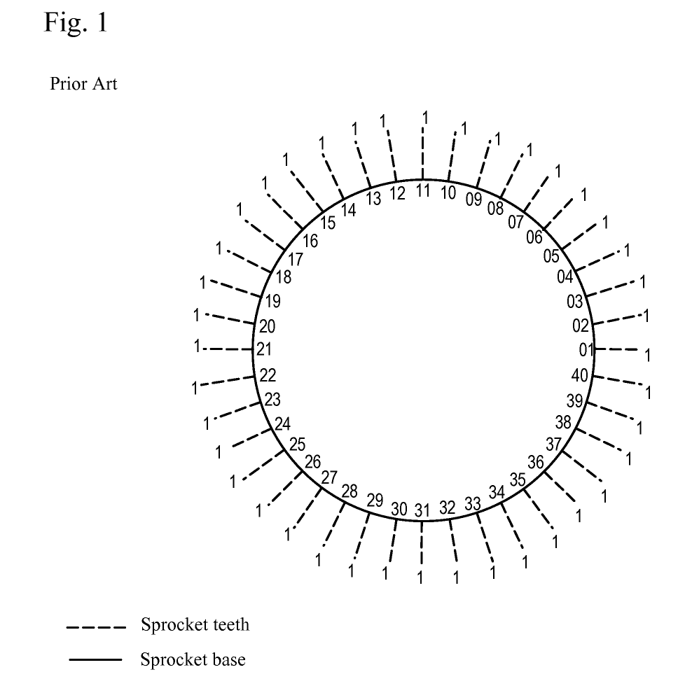

### DETAILED DESCRIPTION OF THE INVENTION

The present invention interrupts the periodicity in the prior art baseline sprocket by introducing calculated variations in some of the previously identical sprocket teeth, which decreases the sound energy of the set of the shaft harmonics (Θ), which are a positive integer multiple of k, by redistributing it to other harmonics, thereby achieving an overall NVH attenuation. The extent of redistribution of energy primarily depends on the types and extent of geometric variations on the original tooth design and distribution of these tooth variants on the sprocket.

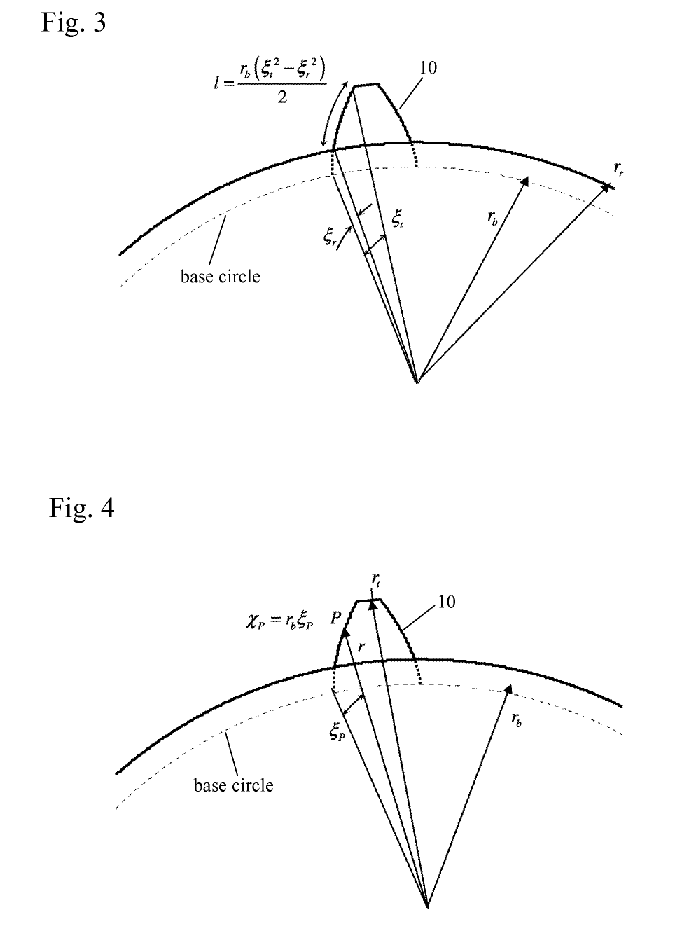

Involute teeth are those in which the profile in a tranverse plane (exclusive of the fillet curves) is the involute of a circle. FIGS. 3-4 show an involute curve 10 with its various properties. The present invention creates tooth variants in such a way that each variant has a different involute length l between the root rᵣ and tip radii rᵢ of the sprocket and each variant has a different curvature χ at a point P on a radius r.

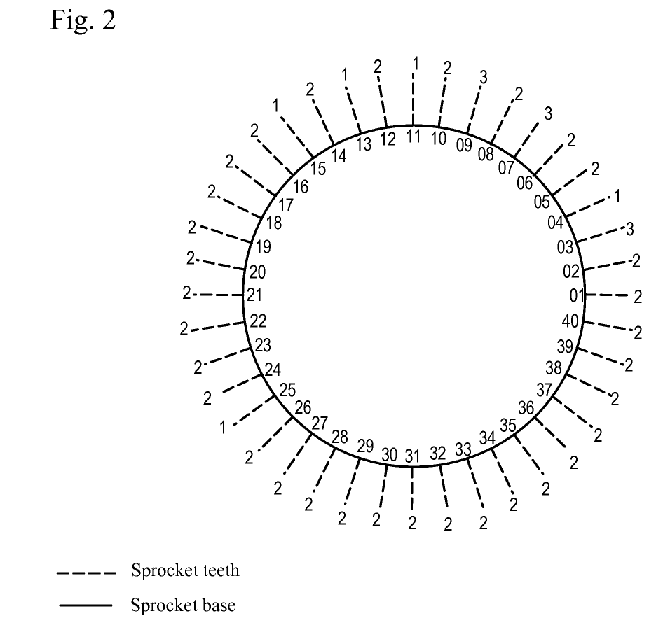

FIG. 2 shows a 40 tooth sprocket with 3 different types of teeth labeled 1, 2 and 3 arranged in one specific way. Given m variations of teeth, and k number of teeth on a sprocket, there can be m^{k} different ways of arranging the variants. Specifically, since k=40 (forty teeth on the sprocket), and m=3 (three tooth variants) in this figure, there can be more than 1 billion trillion (˜10¹⁹) ways to arrange the teeth. An optimization exercise is used to yield a minimum NVH levels at the frequencies and loads of interest for a given application.

From calculus, we know that the curvature of a parametric curve (y≡y(θ), x≡x(θ)) at any given point P is given by the following expression:

$$𝒳 = \frac{{[ {( \frac{d x}{d θ} )}^{2} + {( \frac{d y}{d θ} )}^{2} ]}^{3 / 2}}{\frac{d y}{d θ} \frac{{d}^{2} x}{d {θ}^{2}} - \frac{d x}{d θ} \frac{{d}^{2} y}{d {θ}^{2}}} \qquad ( 0.1 )$$

For an involute curve the equation simplifies to

χ_{P}=r_{b}ξ_{P} (0.2)

Here, χ_{P} and ξ_{P} are the curvature and roll angle at an arbitrary point P of the involute respectively. Using the properties of an involute curve, it can also be shown that the length of the involute between the root and the tip radii is given by the following expression:

$$l = \frac{{r}_{b} ( {ξ}_{t}^{2} - {ξ}_{r}^{2} )}{2} \qquad ( 0.3 )$$

Roll angle and pressure angle (PA) are related by the following expression for an involute tooth:

χ=tan(ζ) (0.4)

From (0.3) and (0.4), we have

$$l = \frac{{r}_{b} ( {tan}^{2} ( {ζ}_{t} ) - {tan}^{2} ( {ζ}_{r} ) )}{2} \qquad ( 0.5 )$$

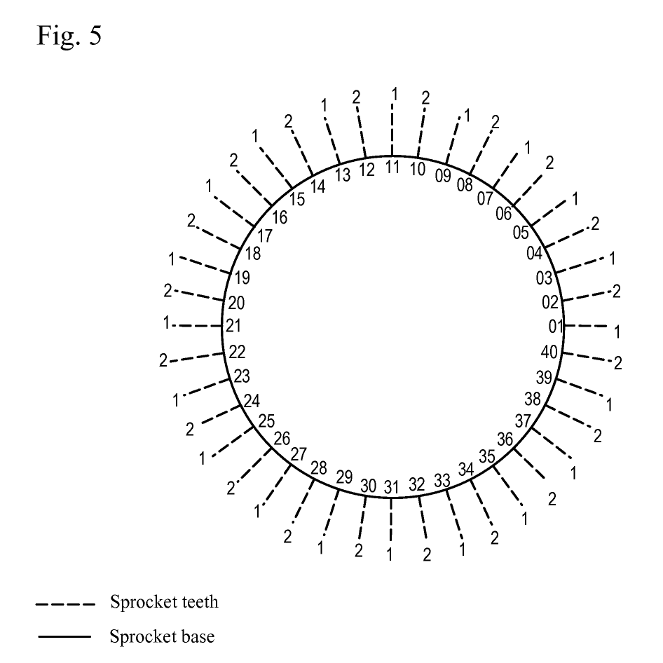

Referring to FIG. 5, the random sprocket of the present invention has two different tooth variants along the outer circumference of the sprocket. The variants are arranged in an alternating arrangement, with the first tooth variant adjacent to the second tooth variant, but other configurations that randomize the occurrence of the first and second tooth variants or the ones that exhibit more than two variants are also possible. The two variants differ in the length of the involute and the curvature at a given radius. In this embodiment, the length of the involute will vary based on the application and size of sprocket and is not limited to the values designated in the examples below.

Chains which rotate upon the sprocket are assembled by putting together various links. For NVH attenuation reasons, chains are almost never entirely made using only one type of link. Links that differ from each other slightly are assembled together in a pre-determined fashion. A chain that is assembled using multiple types of links will be henceforth referred to as a “random chain” to distinguish it from a baseline chain, which uses only one type of link. The random chains in the following examples contain two different link types, first link type (link-1) and second link type (link-2). The baseline chains contain either first link type links (link-1 chain) or second link type links (link-2 chain).

As used below, the term “random sprocket” is a sprocket of the present invention in which at least two variants of teeth that differ from each other in length of the involute curve and the curvature are present on the outer circumference of the sprocket. As used below, the term “baseline sprocket” refers to a sprocket that uses only one tooth variant. Each tooth on a baseline sprocket is like any other one on that sprocket.

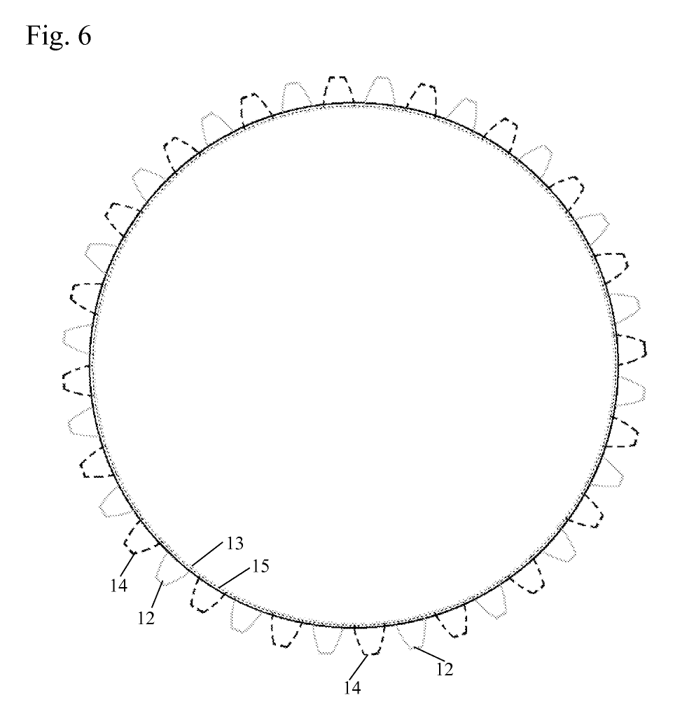

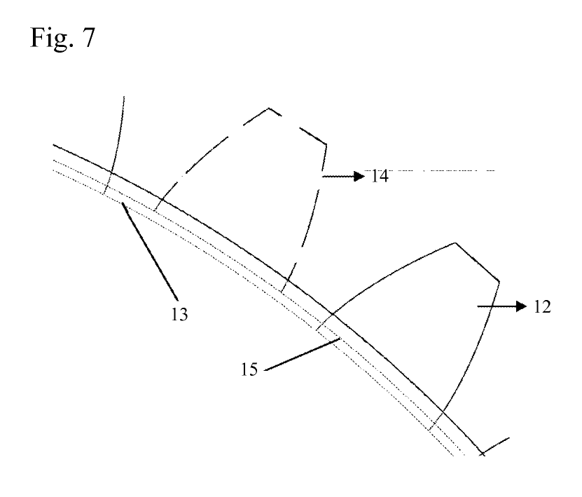

FIG. 6 shows a sprocket that was used in the following examples and has been drawn to scale. FIG. 7 shows an exploded view of the two tooth variants 12, 14 and their base diameters 13, 15 respectively. The first tooth variant 12 of the sprocket has a base diameter 13 and the second tooth variant 14 of the sprocket has a base diameter 15. The tooth variants 12, 14 differ from each other in the length of the involute curve and the curvature at a given radius of the sprocket. In these examples, the involute lengths/of the two tooth variants 12, 14 differ by a small amount of 0.0474 mm.

The following examples of NVH results were obtained from a transfer case application where the sprocket were run in ramp-up conditions (i.e the speed of the sprocket was increased with time) using a semi-anechoic dynamometer for various input loads to the sprocket using the following chain and sprocket configurations.

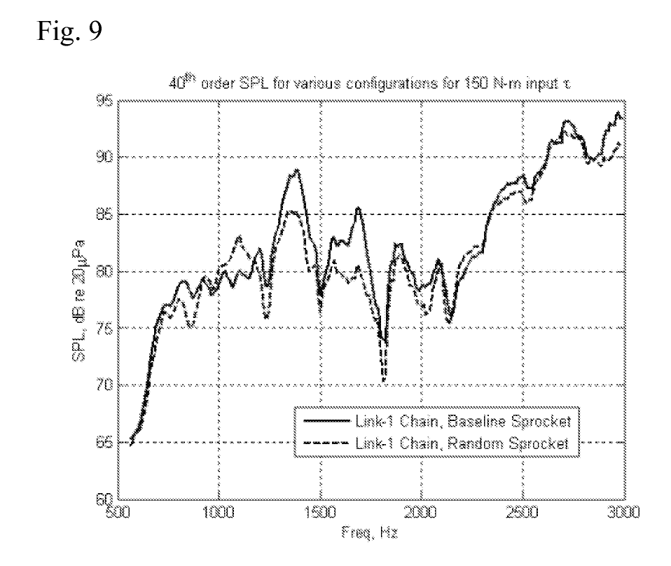

1. Baseline sprocket with baseline chain (link-1 chain) for 150 N-m input torque. (FIG. 9)

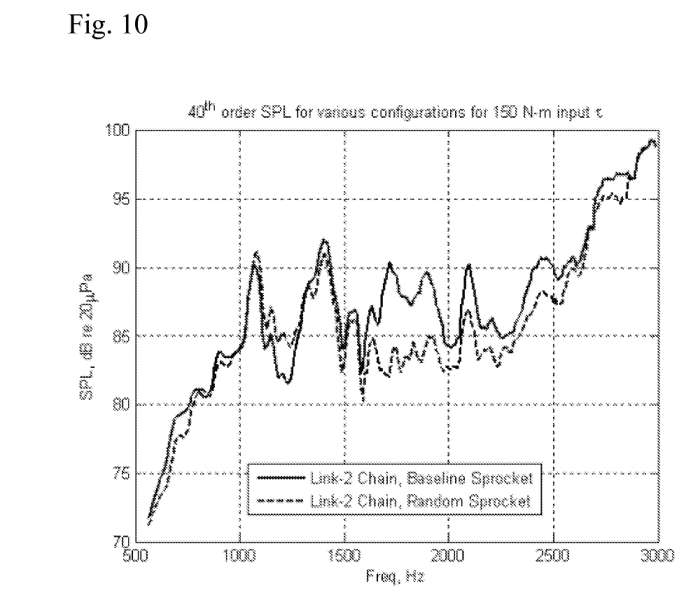

2. Baseline sprocket with baseline chain (link-2 chain) for 150 N-m input torque (FIG. 10).

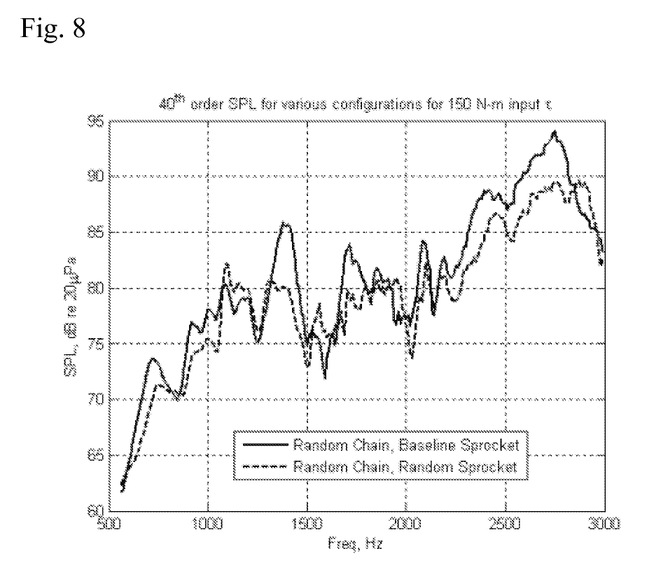

3. Baseline sprocket with random chain for 150N-m input torque (FIGS. 8, 11, 12).

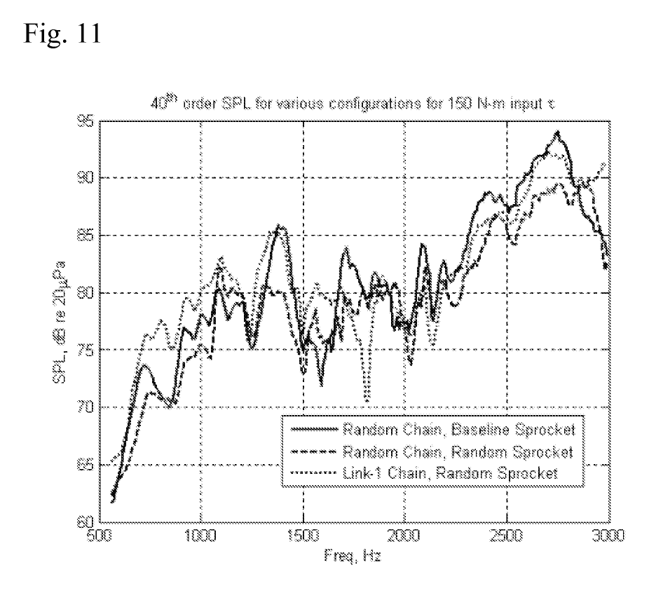

4. Random sprocket with baseline chain (link-1 chain) for 150 N-m input torque (FIGS. 9, 11).

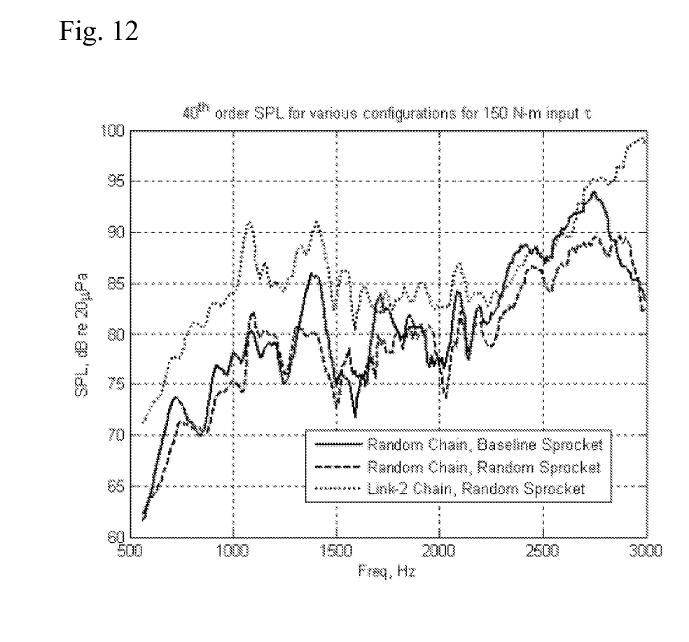

5. Random sprocket with baseline chain (link-2 chain) for 150 N-m input torque (FIGS. 10, 12).

6. Random sprocket with random chain for 150N-m input torque (FIGS. 8, 11, 12).

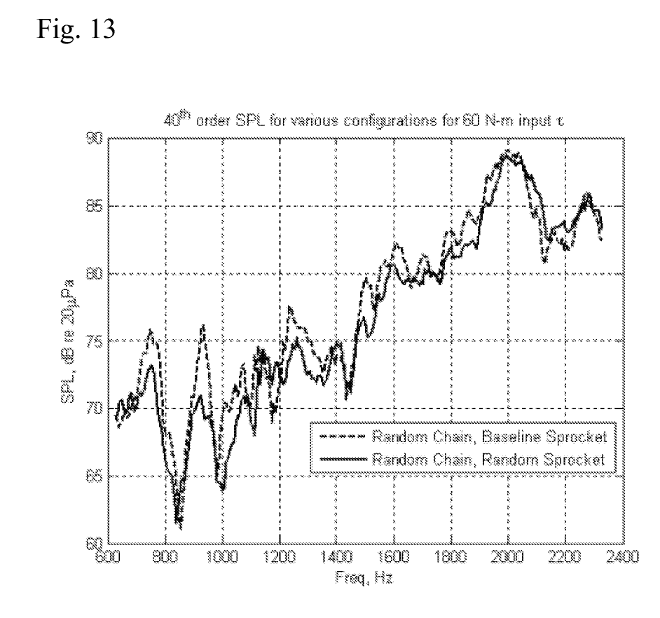

7. Random sprocket with random chain for 60 N-m of input torque (FIG. 13).

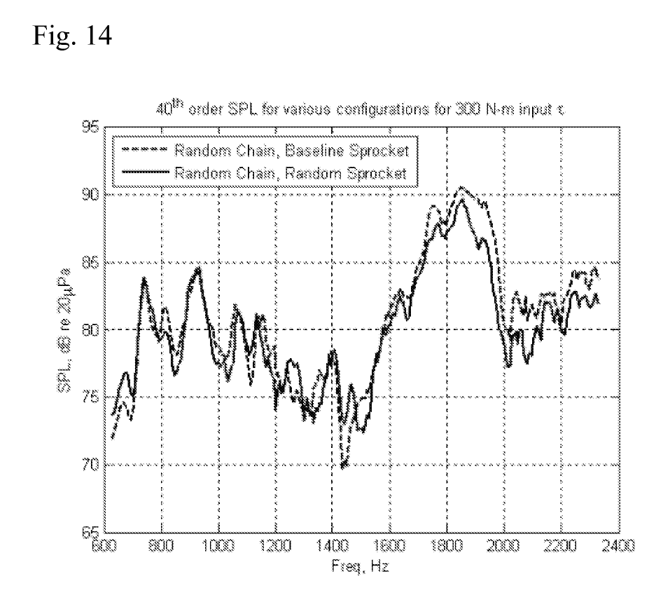

8. Random sprocket with random chain for 300 N-m of input torque (FIG. 14).

FIGS. 8-10 compare the noise performance of a random sprocket with a baseline sprocket. Independent of what type of chain is used, if a random sprocket, with at least two tooth variants with variable involute length, is used instead of a baseline sprocket, the NVH performance improves almost along the entire frequency bandwidth. At some frequencies, the reduction in NVH is greater than 10 dB which signifies more than a three fold noise reduction.

FIGS. 11-12 compare the noise performance of a baseline sprocket with a random chain, a random sprocket with a baseline chain and a random sprocket with a random chain. It can be seen that using a random sprocket with a random chain produces an NVH response that is better than using either a random chain with a baseline sprocket or a random sprocket and a baseline chain. While the chain randomization helps, sprocket randomization can greatly supplement the benefits of using a random chain.

FIGS. 13-14 compare the NVH performance of a random chain with a random sprocket and a random chain with a baseline sprocket for two different loads of 60 and 300 Nm. The trends that were observed for 150 Nm load were observed for these loads as well.

The figures shown herein are only exemplary in nature. As mentioned before, different tooth variants can be arranged m^{k} different ways within the spirit of the present invention. While only one arrangement of two teeth variants on a forty tooth sprocket is discussed herein, these examples show that tooth variability as obtained by using different involute lengths of the teeth on the same sprocket and teeth arrangement with the aforementioned tooth variants can be used to obtain better system NVH performance. Introducing intentional and calculated geometric variability in teeth and optimized distribution of these different types of teeth (variants) on the sprocket gives large NVH benefits. One of the ways to achieve the variability is to have tooth variants that are created using varying involute length and curvature (at a given radius). Once multiple designs or variants for teeth are obtained, they can be arranged on the sprocket in millions of different ways. Each different arrangement gives a different NVH result. Using optimization exercises, the best arrangements can be chosen.

Using random sprockets in combination with random chains produces results that are better than when only one of them is made random.

As mentioned before, there are m^{k} different ways of arranging the variants on a sprocket. Each arrangement gives a different NVH response. An optimization process is used to identify one of the best arrangements for a given application. The process follows the following steps:

1. For the application of interest, conduct a trial to obtain baseline noise profile (performance).

2. From the baseline noise profile, identify the harmonics where the noise is of concern. Usually the first few orders are of the greatest concern. In a typical automotive case application, higher harmonics contribute less to the overall noise levels.

3. In the harmonics of interest, identify the frequency bands where the noise performance is of concern. The customer may also specify what noise levels are objectionable.

4. Identify the tooth variants that can be used for the sprocket. The tooth variants differ from each other in the involute length by a small amount. Any number of variants may be used.

5. Determine which tooth variants can be used for a specific location on the outer circumference of the sprocket using a mathematical routine such as discrete sequential quadratic programming (SOP) based optimization subroutines. Other standard optimization sequences can be used as well. The subroutines essentially find a minimum of sound pressure levels when the tooth variants are placed in specific locations on the outer circumference of the sprocket. In theory, each tooth location on the sprocket can seat any of the tooth variants.

6. Change the tooth sequence depending upon optimization subroutine's logic. After the change in tooth sequence is made, the chain sprocket system may be tested for noise or run through a simulation to generate a new noise profile.

7. Compare the new noise profile to the baseline noise profile at the frequencies of interest. If the noise quality has improved, the change in tooth sequence is accepted. Otherwise, the change in tooth sequence is rejected.

8. Repeat steps 6-7 are until a user deems the improvement to noise levels are being adequate to meet the user set requirements.

### LIST OF SYMBOLS AND DEFINITIONS

k Number of teeth on an outer circumference of a sprocket
Θ Set of all shaft harmonics which are a positive integer multiple of k
m Variations of teeth (number of tooth variants)
r_{b} Base radius. The base radius is the distance from the center of the sprocket to the base circle from which involute tooth profiles are derived.
r Radius
rᵣ Root radius. The root radius is the distance from the center of the sprocket to the bottom of the physical involute tooth.
rₜ Tip radius. The tip radius is the distance from the center of the sprocket to the tips of the sprocket teeth.
χ Curvature
l Involute length. The involute length is the distance from the bottoms of the tooth spaces or root to the tip of the sprocket tooth or tip radii.
ζ Pressure angle. The pressure angle is the angle at a pitch point between the line of pressure which is normal to the tooth surface
ξ Roll angle. The roll angle is the angle whose arc on the base circle or radius unity equals the tangent of the pressure angle at a selected point on the involute.
ξᵢ Roll angle at the tip circle. The roll angle at the tip circle is the angle arc on the base circle or radius unity equals the tangent of the pressure angle at the tip circle or outer diameter of the sprocket.
ξᵣ Roll angle at the root radius. The roll angle at the root radius is the angle arc on the base circle or radius unity equals the tangent of the pressure angle at the root radius.
NVH Noise Vibration and Harshness

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A sprocket comprising:
a plurality of teeth along an outer circumference of the sprocket, wherein the teeth are comprised of at least a first tooth with a first involute length between a root and a tip radii of the sprocket and a first curvature at a given radius and at least a second tooth with a second involute length between a root and a tip radii of the sprocket and a second curvature at the given radius, which is different than the first curvature.

2. The sprocket of claim 1, further comprising a third tooth with a third involute length between the root and the tip radii of the sprocket and a third curvature at a given radius, the third curvature being different than the first curvature or the second curvature.

3. A system comprising:
a random chain with at least two types of links; and
a sprocket meshing with the random chain comprising a plurality of teeth along an outer circumference of the sprocket, wherein the teeth are comprised of at least a first tooth with a first involute length between a root and a tip radii of the sprocket and a first curvature at a given radius and at least a second tooth with a second involute length between a root and a tip radii of the sprocket and a second curvature at the given radius, which is different than the first curvature.

4. The system of claim 3, further comprising a third tooth with a third involute length between the root and the tip radii of the sprocket and a third curvature at a given radius, the third curvature being different than the first curvature or the second curvature.
